(19) United States
(12) Patent Application Publication
(10) Pub. No.: US 2008/0042881 A1
(43) Pub. Date: Feb. 21, 2008

(54) VEHICLE TAG USED FOR TRANSMITTING VEHICLE TELEMETRY DATA

(75) Inventors: Timothy C. Harrington, Los Gatos, CA (US); Douglas Bowman, Capitola, CA (US); Walter Johnson, San Jose, CA (US); Richard Benner, San Martin, CA (US); Ronald L. Capener, San Jose, CA (US); Huong Han, San Jose, CA (US)

Correspondence Address: CHRISTOPHER F. REGAN, ESQUIRE;ALLEN, DYER, DOPPELT, MILBRATH & GILCHRIST, P.A., P.O. Box 3791, Orlando, FL, 32802-3791, US

(73) Assignee: WHERENET CORP.

(21) Appl. No.: 11/782,130

(22) Filed: Jul. 24, 2007

Related U.S. Application Data
(62) Division of application No. 10/855,871, filed on May 27, 2004.
(60) Provisional application No. 60/473,805, filed on May 28, 2003.

(51) Int. Cl. G08G 1/123

(52) U.S. Cl. 340/989; 342/450; 701/29

(57) ABSTRACT

A vehicle tag includes a housing and a tag connector supported by the housing for connecting to a diagnostic jack of a vehicle on-board diagnostic (OBD) system. A tag transmitter is carried by the housing and operative with the tag connector for receiving telemetry data from the OBD system and transmitting the telemetry data in an REF pulse.

### RELATED APPLICATION

This application is a divisional of Ser. No. 10/855,871 filed on May 27, 2004, which is based on provisional application Ser. No. 60/473,805 filed May 28, 2003, the disclosures of which are hereby incorporated by reference in their entirety.

### FIELD OF THE INVENTION

The present invention relates to the field of communications, and more particularly, the present invention relates to receiving and transmitting vehicle telemetry data and related methods.

### BACKGROUND OF THE INVENTION

Various proposals have been made for collecting and transmitting vehicle telemetry data, such as at a rental car agency. This would expedite check-in of rental cars. For example, the vehicle mileage can be obtained by reading the odometer and ascertaining fuel levels through an on-board computer. vehicle identification number (VIN) received from the OBD system. The tag transmitter can be operative with different vehicle bus protocols based on a received VIN. These bus protocols can confirm to one of J1850DPW, PWM, controlled area network (CAN), SCP or ISO network standards.

In yet another aspect of the present invention, the OBD system comprises an on-board diagnostic system generation II (OBD-II). The tag transmitter can also be operative for transmitting vehicle diagnostic codes. The tag transmitter is preferably powered from current received from the OBD system through the tag connector. The tag transmitter can be triggered ON at initial connection of the tag connector to a diagnostic jack of the OBD system. The telemetry data can also include odometer and fuel level data.

In yet another aspect of the present invention, a microcontroller is connected to the tag connector and receives a vehicle identification number (VIN) and the telemetry data from the OBD system and determines which vehicle bus protocol to use based on the VIN. A memory can be operative with the microcontroller for storing data relating to different vehicle bus protocols to allow communication between the microcontroller and OBD system of a vehicle having different vehicle bus protocols.

In accordance with the present invention, a system transmits vehicle telemetry data using the vehicle tag to a receiver positioned to receive any RF pulses transmitted from the vehicle tag for further processing of any received telemetry data. This receiver can be positioned for receiving RF pulses at a rental car agency, as one non-limiting example only.

A method is also set forth.

### BRIEF DESCRIPTION OF THE DRAWINGS

Other objects, features and advantages of the present invention will become apparent from the detailed description of the invention which follows, when considered in light of the accompanying drawings in which:

FIG. 1 is a front perspective view of the vehicle tag of the present invention.

FIG. 2 is a rear perspective view of the vehicle tag of FIG. 1 looking into the tag connector.

FIG. 3 is a top perspective view of the vehicle tag of the present invention.

FIG. 4 is an exploded perspective view of the vehicle tag showing the housing, printed circuit board, tag connector and associated components mounted on the printed wiring board, including the tag transmitter and microcontroller.

FIG. 5 is a high level flow chart showing an example of the vehicle tag function when it is initially connected to the diagnostic jack of a vehicle on-board diagnostic (OBD) system.

FIG. 6 is a high level flow chart showing an example of the disconnect operation when the vehicle tag is disconnected from the diagnostic jack.

FIG. 7 is a high level flow chart showing an example of the vehicle tag function when the vehicle is ON and the vehicle tag is in a vehicle ON mode.

FIG. 8 is a high level flow chart showing an example of the vehicle tag function when the vehicle is OFF and the vehicle tag is in a vehicle OFF mode.

FIG. 9 is a high level flow chart showing an example of the vehicle tag function when the vehicle is moving and the vehicle tag is in a vehicle moving mode.

FIG. 10 is a flow chart showing an example of the vehicle tag when the vehicle tag is in sleep mode.

FIG. 11 is a high level flow chart illustrating the function of the vehicle tag when it is in idle mode.

FIG. 12 is a state diagram showing the interconnection among different modes of operation for the vehicle tag.

FIG. 13 is a block diagram showing different functions of the logic used with the vehicle tag.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

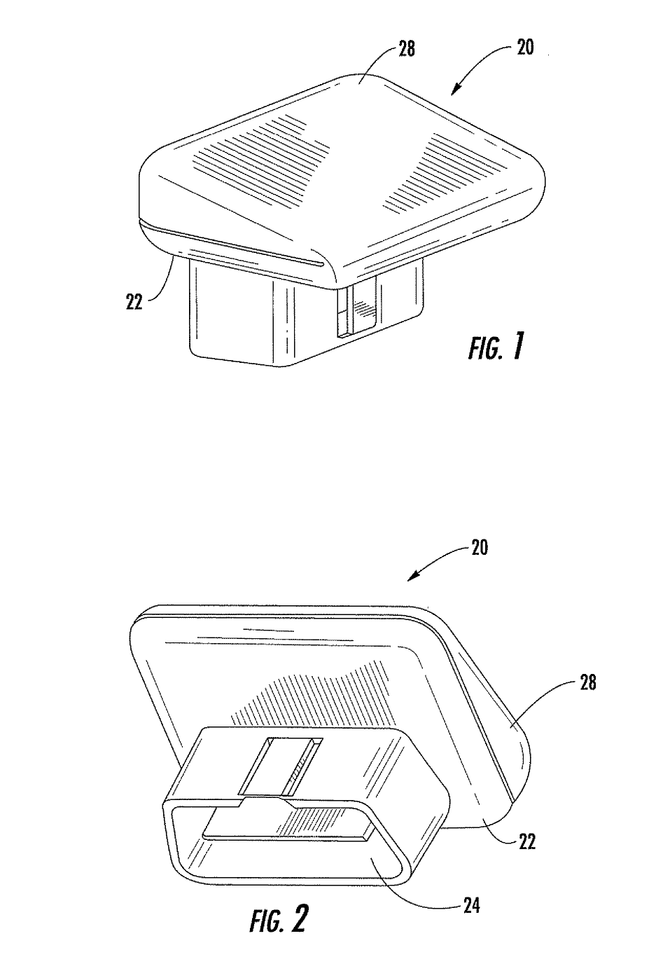

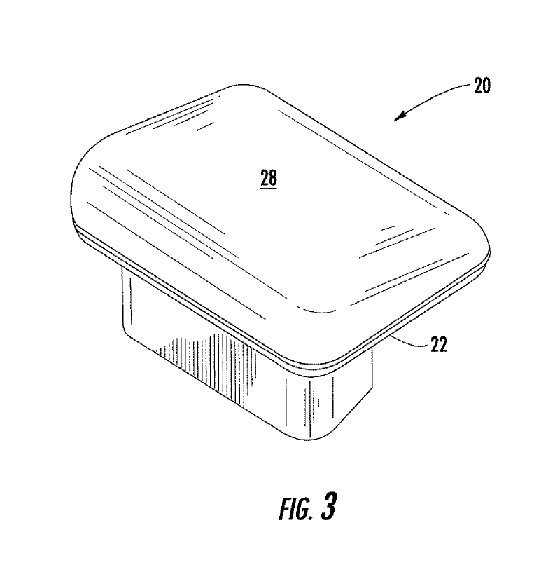

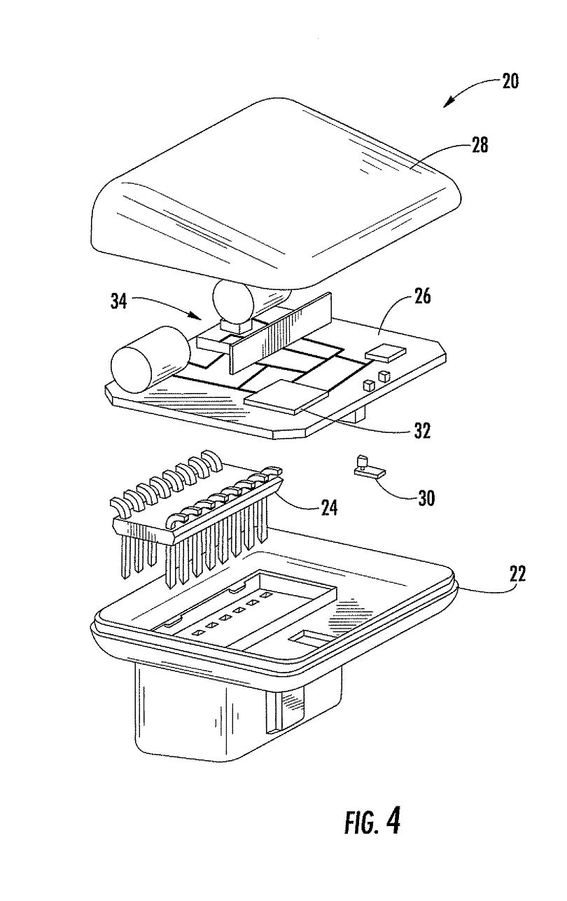

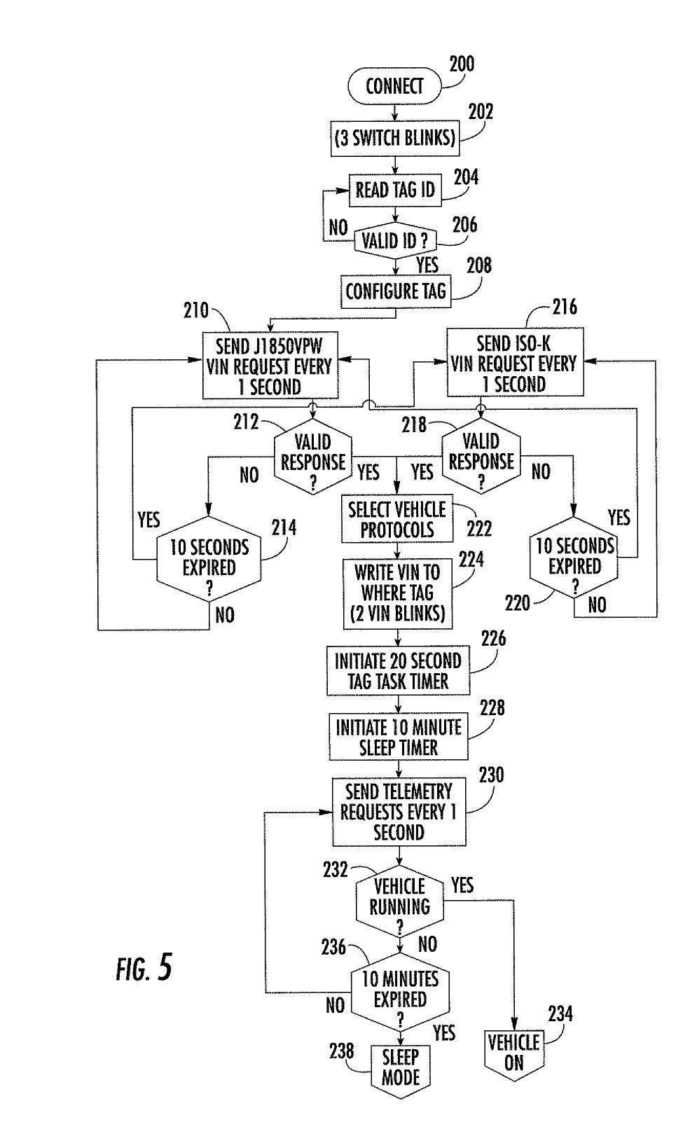

FIGS. 1-3 are perspective views of the vehicle tag 20 of the present invention. FIG. 4 is an exploded perspective view of the vehicle tag 20 showing basic components. The vehicle tag 20 incorporates standard technology found in a WhereNet tag transmitter manufactured by WhereNet Corporation in Santa Clara, Calif. Examples are disclosed in the commonly assigned and incorporated by reference U.S. Patent Nos. or published applications: U.S. Pat. Nos. 5,920,287; 5,995,046; 6,121,926; 6,127,976; 6,268,723; 6,317,082; 6,380,894; 6,434,194; 6,502,005; 6,593,885; 2002/0094012; 2002/0104879; and 2002/0135479.

The vehicle tag 20 is operative similar to the tag as described in the above-identified issued patents and published patent applications. The vehicle tag 20 can transmit or “blink” a short duration, wideband (spread spectrum) pulse of RF energy encoded with information received from an on-board diagnostic (OBD) system, and more particularly, a second generation system known as OBD-II. The vehicle tag is especially operative at a rental car agency or similar location, for example, fleet applications. The vehicle tag can include an oscillator, whose output is fed to a first “slow” pseudorandom pulse generator and to a strobe pulse generator or other circuitry as described in the incorporated by reference patents. It can include a timer and delay circuit and receiver circuitry. A high speed PN spreading sequence generator can be included with a crystal oscillator that provides a reference frequency for a phase locked loop (PLL) to establish a prescribed output frequency, for example, at 2.4 GHz. A mixer and output can be included with a vehicle tag memory that can include a database containing vehicle bus parameters as described in greater detail below.

In the present invention, the vehicle tag would not have to include a magnetic receiver as disclosed in some of WhereNet assigned patents, but would include a microcontroller, an on-board diagnostic connector (tag connector), and at least one transceiver operative with the various vehicle protocols. Basic Rental car returns could be automated and transmitted to a base station at the rental car agency.

Some prior art proposals use an interrogation beacon to interrogate a transponder that is connected to the on-board computer, which then activates a transmitter of the transponder and transmits data relating to the fuel level, mileage and other vehicle data. These systems rely on interrogation beacons for activating the transponder. Also, some of the systems connect directly to the on-board computer through a sophisticated interface. This interface adds costs to the overall system.

### SUMMARY OF THE INVENTION

It is therefore an object of the present invention to overcome the disadvantages of the vehicle transponders that are interrogated and transmit vehicle data as identified above.

In accordance with the present invention, a vehicle tag has a housing and tag connector supported by the housing for connecting to a diagnostic jack of a vehicle is on-board diagnostic (OBD) system. A tag transmitter is carried by the housing and is operative with the tag connector for receiving telemetry data from the OBD system and transmitting the telemetry data in an RF pulse. The tag connector preferably comprises a J1962 compatible connector.

In one aspect of the present invention, the RF pulse comprises a pseudorandom spread spectrum RF signal encoded with the telemetry data. A timer circuit can be used for timing transmission of the RF pulses, which can be based on a determined idle, vehicle OFF, vehicle moving or vehicle ON mode. A tag transmitter is also operative for transmitting the components of the vehicle tag 20 of the present invention are shown in the exploded perspective view of FIG. 4, showing a housing base 22, the tag connector 24 soldered to a printed circuit board 26 and contained within the housing base 22, and a housing cover 28. The tag connector 24 is typically a J1962OBD-II compatible connector for connection to OBD-II systems, but other tag connectors could be used depending on vehicle and/or OBD designs in use. An LED 30 is indicative of vehicle tag and visible through an LED opening in the cover 28 operation and is mounted to the printed circuit board 26. The printed circuit board 26 includes a microcontroller 32 and any necessary transceivers and associated components 34. The microcontroller 32 communicates to the vehicle through the connector 24 into the vehicle OBD-II system to gather telemetry information such as the mileage, fuel, speed, engine state and other parameters that make up the telemetry data. The system transmits this information directly to a CMOS application specific integrated circuit (ASIC) of the vehicle tag, which causes the vehicle tag to blink out the telemetry in a manner similar to the blinking described in the above-identified patents.

The vehicle tag is derivative of the current WhereNet Wheretag III architecture as manufactured by WhereNet Corporation in Santa Clara, Calif. The vehicle tag 30 is a single assembly that contains the electronic components required for operation, including a vehicle bus interface, as a connector, the controller and transceiver as described before. The vehicle tag 20 supports the querying of a vehicle data bus for identification and diagnostic information. The vehicle tag of the present invention will typically be used for buses conforming to the J1850 specification, but also could be compatible with the newly evolving CAN or other vehicle bus specifications.

The tag connector 24 is compatible preferably with the J-1962 vehicle diagnostic jack that is typically located under a vehicle dash. The software used for the vehicle tag 20 can also be compatible with the Visibility Server Software Suite manufactured and sold by WhereNet Corporation, which is operable to accept, process, and forward data packets. A programming module can attach to a portable data terminal (PDT) to load vehicle parameters and firmware upgrades into the vehicle tag.

The vehicle tag 20 of the present invention includes all functions of a current Wheretag III architecture (except in possible cases no magnetic receiver) and can interface to the vehicle bus, including J-1850, ISO-K, CAN and all variants, through the OBD diagnostic jack. It can read the vehicle identification number (VIN), odometer, fuel level, engine running, and/or diagnostic codes (DTC). It can detect an disconnect to notify the system, even if it is disconnected while out of range. It can detect vehicle motion to the odometer or other circuits operating in a fast transmit mode. The vehicle tag is preferably powered by the vehicle electrical system through the diagnostic jack and into the OBD-II. It would typically be shipped from a factory in a non-blinking state to be triggered by a “connect” to a vehicle, as will be explained in greater detail below. A wired or wireless method and circuit can reprogram a flash memory for the microcontroller, using a handheld terminal with a programming module. The vehicle number, such as in the hardware and firmware, can be transmitted in a message at a reasonable rate. It is possible to detect key ON and motion.

As shown in FIGS. 1-4, the vehicle tag of the present invention is a single assembly that includes the tag connector 24 and tag housing base 22 and cover 28 as one modular unit. Additional cable extensions could be used to connect to vehicles having an odd placement of jack. The vehicle tag preferably connects to the J-1962 connector. Input voltage can be a pass-through to provide power to the vehicle tag. Nominal voltage, for example, the SAE J1211, is 14.2 volts, running with 24 volt jump starts, and 4.5 volts during cold cranking. The vehicle tag is preferably a direct connect to a battery using fuses. SAEJ 1211, Section 14.11 defines the transience to which the tag can be designed. It is typically sealed against dust and rain (IP 54) and is operative at humidity levels of 5 percent to 99 percent. It is designed for vibration specifications to SAE. It has 15 kilovolts through a 2.0K resistor from 300 of and allows “operating anomalies.” It preferably is designed for an operating temperature range of −30 degrees C. to +70 degrees C., and includes a storage temperature range of about −35 degrees C. to about +85 degrees C. It is compliant with requirements for CE certifications and “e” marked for use in EU counties. In one aspect of the present invention, the housing base 22 and cover, in one example, is about 2.410 by 1.64 by 0.720 inches.

As to functionality, the RF components of vehicle tag 20 of the present invention have the same functionality as a WhereTag III device that is part of the WhereNet Real-Time Locating System (RTLS) as explained in the incorporated by reference patents. The tag 20 can operate in the globally accepted 2.4 GHz frequency band and transmit spread spectrum signals in excess of 300 meters outdoors, at less that 2 mW. It is operable with the Visibility Service Software that it offered by WhereNet Corporation, as an integrated software package, that allows management of assets and resources as well as the WhereNet Real-Time Locating System.

The Visibility Service Software is a distributed Windows service that can include configuration tools, diagnostics, system alerts, an interface manager, and installation tools. This software package allows for e-mail and paging notifications. SNMP MIB definition extensions can be included, allowing the RTLS system to be managed as part of an enterprise standard IT infrastructure. A software launcher can provide single point of entry and software modules for operation, administration, diagnostics, installation and documentation. Any administration modules can provide tools to allow configuration of the RTLS system to meet testing requirements. The vehicle tag 20, of course, is operable without any RTLS system and can be used at rental car agencies and close proximity and similar applications.

A user can configure who was notified by specific alerts and how they are notified. Diagnostic modules can contain the tools to allow monitoring of the health and status of the RTLS and monitor operation of the data acquisition module and tools to monitor the health and status of the physical hardware. Any installation and documentation modules are tools to be used during the installation and initial configuration of the RTLS system. Installation, operation and troubleshooting are included.

A proximity communication device can be used in association with a vehicle tag of the present invention, and can be a WherePort device, such as manufactured by WhereNet Corporation. This device is used to trigger vehicle tags and transmit different “blink” patterns or originate other functions.

The vehicle tag of the present invention is operative with the On-Board Diagnostic System, Generation II (OBD-II), which determines if a problem exists. OBD-II can have corresponding “diagnostic trouble codes” stored in the vehicle computer's memory, and a special lamp on the dash board (called a malfunction indicator lamp (MIL)), which is illuminated when a problem is detected. Engines in newer vehicles are electronically controlled and sensors and actuators sense the operation of specific components, such as the oxygen sensor, and actuate others, such as fuel injectors, to maintain optimal engine control. A “power train control module” (PCM) or “engine control module” (ECM) controls the systems as an on-board computer, which monitors the sensors and actuators and determines if they are working as intended. The on-board computer detects malfunction or deterioration of the various sensors and actuators and can be addressed through the jack in which the vehicle tag of the present invention is connected.

The vehicle tag 20 of the present invention is operative with different vehicle tag electronics and OBD-II systems. The On-Board Diagnostics Phase II (OBD-II) has increased processing power, enhanced algorithms and improved control as compared to earlier generation systems. Different network standards are used. These include the J1850VPW used by GM (Class II) and Chrysler (J1850). The VPW (variable pulse width) mode is sometimes used with Toyota and Honda and is operative at 10.4 Kbps over a single wire. The J1850PWM has been used by Ford (Standard Corporate Protocol, SCP) and sometimes used by Mazda and Mitsubishi. SCP is 41.6 Kbps over a two wire balanced signal. ISO 9141 and ISO 9141-2 (ISO 9141 CARB) is sometimes used in Chrysler and Mazda products and more commonly used in Europe. It is operative at 10.4 Kbps over a single wire.

The network protocols are incompatible and describe physical and data link layers with the application layer used for specific messages. The vehicle tag 20 of the present invention includes the requisite microcontroller 32 and vehicle database and algorithms stored in vehicle tag memory to be operative with the different protocols. A controller area network (CAN) can address data link and application layers, but would not address physical layer or speed parameters. It is operative as high-speed (ISO 1898) and low speed (ISO 11519). A Class II GM implementation using the J1850VPW implementation and a single wire CAN, and SCP have been used. The vehicle tag of the present invention can be adapted for use with device net, J1939, J1708, a time triggered protocol (TTP), an ITS data bus, and PC type networks. The J1850VPW (variable pulse width) mode has symbols found in the J1850 specification, and operates at a nominal 10.4 Kbps. It uses a single wire with a ground reference and bus idle “low” as ground potential. The bus “high” is +7 volts and operative at +3.5 volts as a decision threshold, in one example. The bus “high” is dominant and has zero bits. Typically messages are limited to 12 bytes, including cyclical redundancy checks (CRC) and IFR bytes. It can use carrier sense multiple access with non-destructive arbitration (CSMA/NDA). A J1850 Pulse Width Modulation (PWM) has symbols defined in the J1850 specification and uses 41.6 Kbps. It can use a two wire differential signal that is ground referenced and a bus “high” as +5 volts, as a dominant state.

The vehicle tag of the present invention can also be operative with the ISO 9141-2 standard, which is UART based and operative at 10.4 Kbps. The K-line can be required as ground reference, and used for normal communications. An L-line can be ground referenced.

The vehicle tag of the present invention is designed to be easy to install and de-install, and can use 802.11 telemetry and location applications for fuel cost recovery and odometer verification, by transmitting data regarding the vehicle identification, the fuel and mileage. In rental car applications, it would improve customer experience for faster check-in and reduce labor costs and improve asset use. The vehicle tags 20 can be web-enabled.

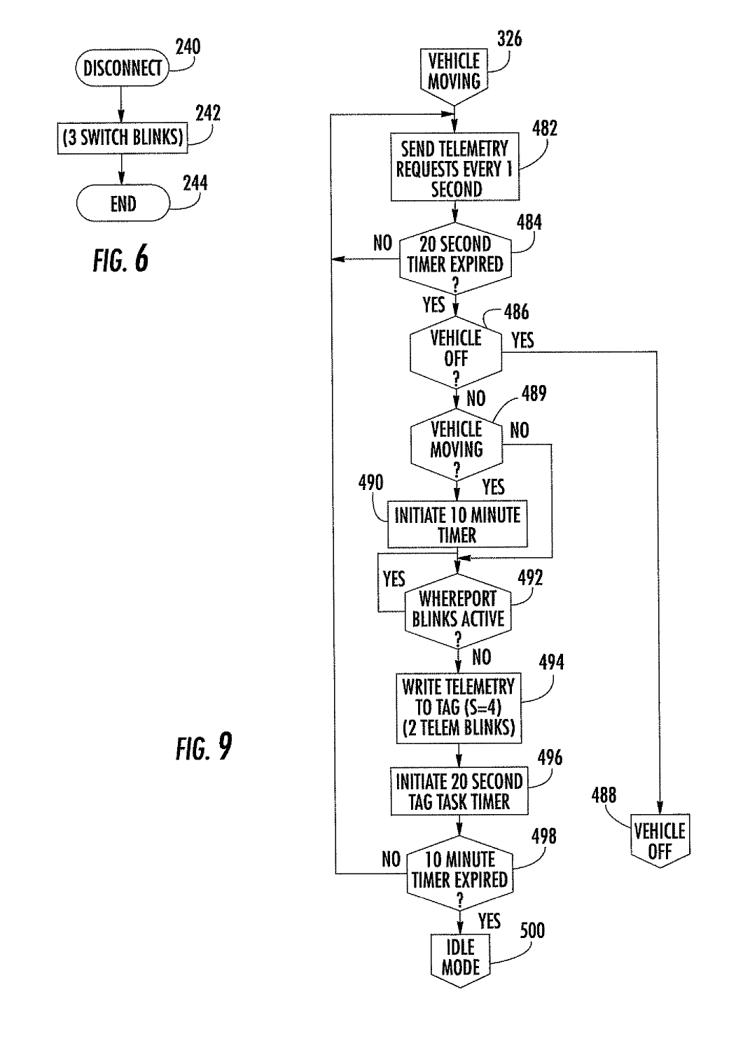

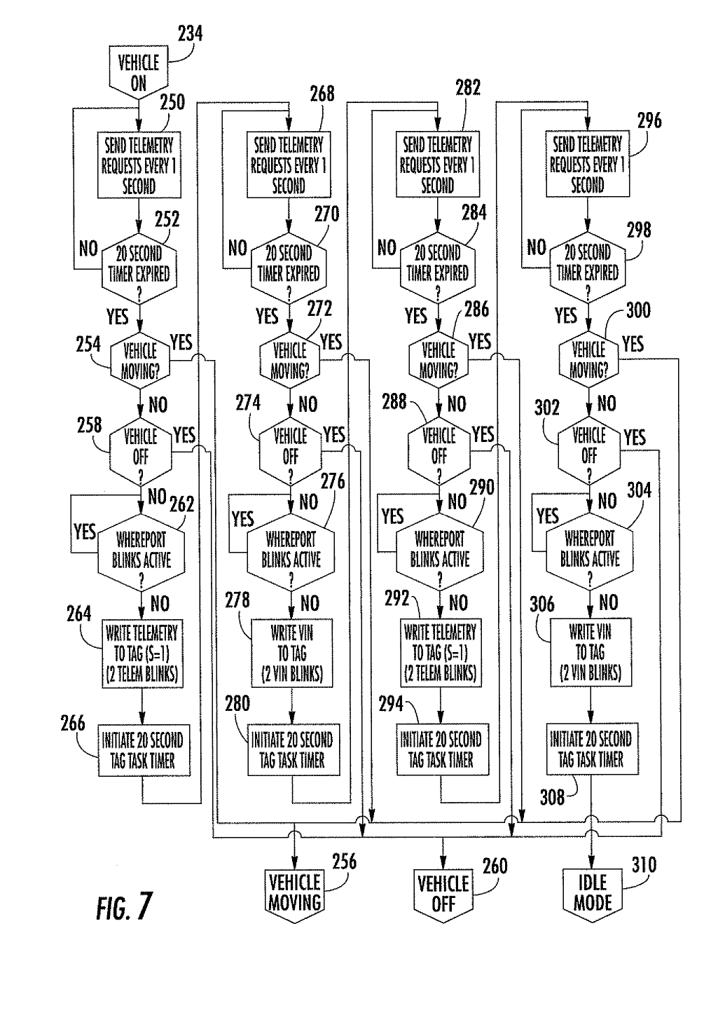

FIGS. 5-12 are flow charts that show high level operation of the vehicle tag 20 of the present invention, indicating the function of the vehicle tag and its blinking operation when the vehicle tag is initially connected and operative when the vehicle is ON, OFF, moving, or at idle or other modes of operation.

FIG. 5 is a first flow chart depicting the vehicle tag operation and “blinking” status when it is initially connected (Block 200) to the vehicle. At this time, three switch blinks occur (Block 202). The tag ID is red (Block 204) and a valid ID is determined (Block 206). If the ID is not valid, the tag ID is read again (Block 204). If a valid ID occurs, the tag is configured (Block 208) and the J1850VPW vehicle identification (VIN) request is sent every one second to determine the VIN (Block 210). If a valid response is not received (Block 212), ten seconds is used as a time period, and if it has expired (Block 214), on the ISO-K vehicle identification number request is sent every one second (Block 216) in this non-limiting example. If ten seconds has not expired, the J1850VPW VIN request is sent every one second (Block 210). If in the case where the ISO-K request has been sent, and a valid response has not been received (Block 218), then ten seconds is set (Block 220), and if it has not expired, the ISO-K is sent again (Block 216). If ten seconds has expired, the J1850VPW is sent (Block 210). In any event, whether the J1850VPW or ISO-K is sent, if there is a valid response (Blocks 212 and 218), vehicle protocols are selected from the database (Block 222). The vehicle identification number is written into the vehicle tag and two VIN blinks occur (Block 224). A 20 second tag task timer is initiated (Block 226). A ten minute sleep timer is initiated (Block 228). The telemetry requests are sent every one second (Block 230).

At this point a determination is made whether the vehicle is running (Block 232). If the vehicle is running, a vehicle ON status is maintained (Block 234). If the vehicle is not running, then ten minutes is set (Block 236). If this time period has not expired, telemetry requests are sent every one second (Block 230). If ten minutes has expired, the vehicle tag goes into a sleep mode (Block 238).

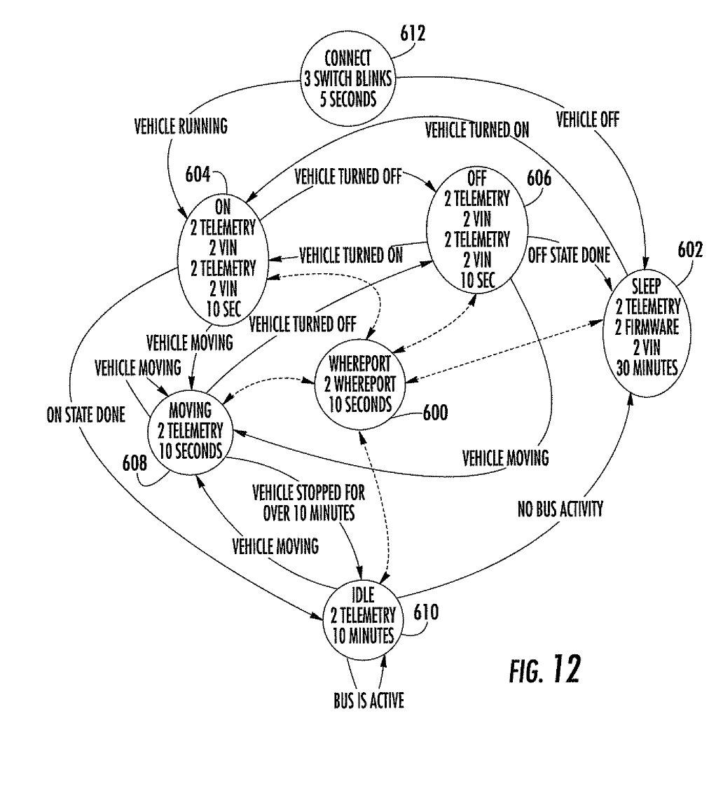

The disconnect operation for the vehicle tag is shown in FIG. 11, for example, when the vehicle tag is disconnected. When the vehicle tag is first disconnected (Block 240), three switch blinks occur (Block 242) and the cycle ends (Block 244).

FIG. 7 is a flow chart showing the function of the vehicle tag when the vehicle is ON (Block 234). Once the vehicle tag has determined that the vehicle is ON, telemetry requests are sent every second (Block 250). The determination is made whether a 20 second timer has expired (Block 252). If it has not expired, the telemetry requests are sent continually every one second (Block 250). If the 20 second timer has expired, a determination is made if the vehicle is moving (Block 254). If the vehicle is moving the vehicle tag enters a vehicle moving status (Block 256).

If the vehicle is not moving, a determination is made whether the vehicle is OFF (Block 258). If the vehicle is OFF, the vehicle tag enters a vehicle OFF status mode (Block 260). If the vehicle is not OFF, a determination is made if a proximity communications device, such as a WherePort port device manufactured by WhereNet, has blinked active (Block 262). If so, the cycle repeats. If not, telemetry is written to the tag (S=1) with two telemetry blinks (Block 264). A 20 second tag task timer is initiated (Block 266). Telemetry requests are sent every one second (Block 268). A determination is made whether a 20 second timer has expired (Block 270). If not, telemetry requests are sent every one second (Block 268).

A determination is made whether the vehicle is moving (Block 272), and if yes, a vehicle moving status mode is entered (Block 256). If not, a determination is made whether the vehicle is OFF (Block 274). If yes, the vehicle OFF mode is entered (Block 260). If not, a determination is made whether the proximity communications device blinks action (Block 276) and if yes, the cycle repeats. If not, the vehicle identification number is written to the tag as indicative of two VIN blinks (Block 278).

A 20 second timer is initiated as a tag task timer (Block 280). At this time, telemetry requests are sent every one second (Block 282). A determination is made whether the 20 second timer has expired (Block 284) and if not, the cycle repeats. If yes, a determination is made whether the vehicle is moving (Block 286) and if yes, the vehicle moving mode is entered (Block 256). If not, a determination is made whether the vehicle is OFF (Block 288) and if yes, the vehicle OFF mode is entered (Block 260).

A determination is then made whether the proximity communication device blinks active (Block 290) and if yes, the cycle repeats. If not, the telemetry is written to the tag (S=1) and two telemetry blinks are initiated (Block 292). A 20 second tag task timer is initiated (Block 294) and telemetry requests are sent every one second (Block 296). A determination is made whether the 20 second timer has expired (Block 298) and if not, the cycle repeats. If yes, a determination is made whether the vehicle is moving (Block 300) and if yes, the vehicle moving mode is entered (Block 256). If not, a determination is made whether the vehicle is OFF (Block 302) and if yes, the vehicle OFF mode is entered (Block 260). If not, a determination is made whether a proximity communication device has blinked action (Block 304) and if yes, the cycle repeats. If not, a vehicle identification number is written to the tag and two VIN blinks occur (Block 306). A 20 second task timer is initiated (Block 308) and the idle mode is entered (Block 310).

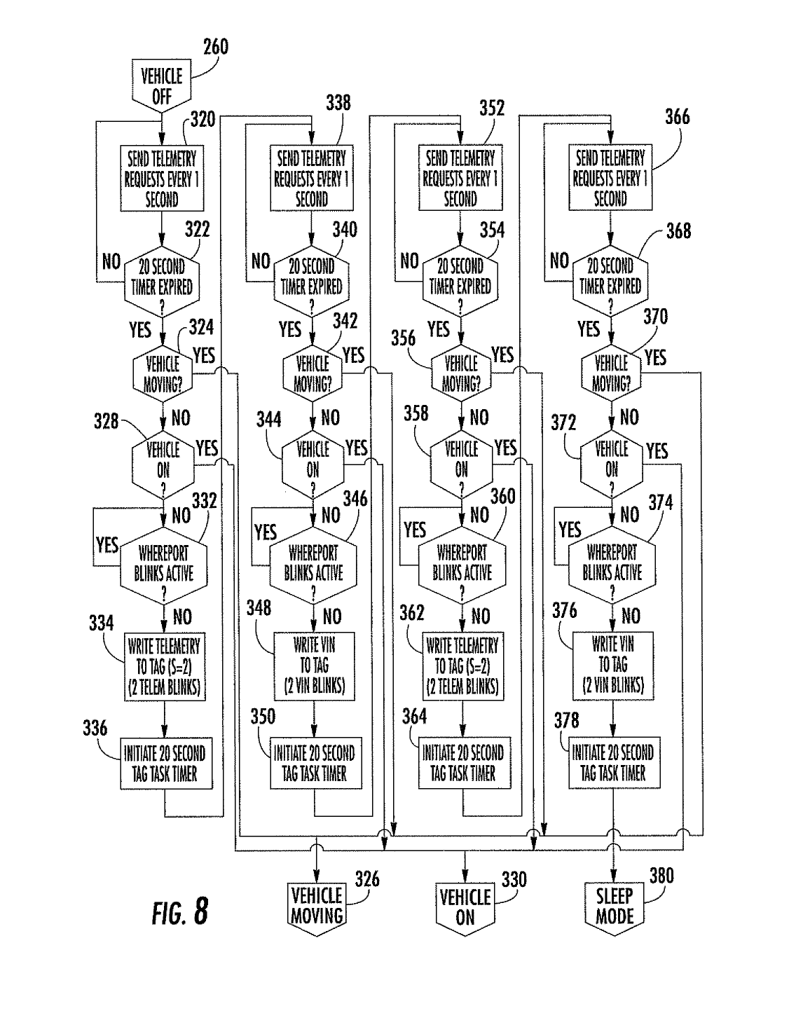

FIG. 8 is a flow chart illustrating the function of the automotive tag when the vehicle OFF mode is entered (Block 260). At this time, telemetry requests are sent every one second (Block 320). A determination is made whether the 20 second timer has expired (Block 322). If not, the cycle is repeated. If yes, a determination is made whether the vehicle is moving (Block 324) and if yes, a vehicle moving mode is entered (Block 326). If not, a determination is made whether the vehicle is ON (Block 328) and if yes, a vehicle ON mode is entered (Block 330). If not, a determination is made whether a proximity communication device blinks active (Block 332). If yes, the cycle repeats and if not, telemetry is written to the tag (S=2) with two telemetry blinks (Block 334).

A 20 second tag task timer is initiated (Block 336) and telemetry requests are sent every one second (Block 338). A determination is made whether the 20 second timer has expired (Block 340) and if not, the cycle repeats. If yes, a determination is made whether the vehicle is moving (Block 342) and if yes, the vehicle moving mode is entered (Block 326). Of course, if the vehicle was not moving a determination is made whether the vehicle was ON (Block 344) and if yes, the vehicle ON mode is entered (Block 330). If not, a determination is made whether the proximity communication device blinks active (Block 346) and if yes, the cycle repeats. If not, the vehicle identification number is written to the tag as two vehicle identification number blinks (Block 348).

The 20 second tag task timer is initiated (Block 350) and telemetry requests are sent every one second (Block 352). A determination is made whether the 20 second timer has expired (Block 354) and if not, telemetry requests are sent every one second. If yes, a determination is made whether the vehicle was moving (Block 356) and if yes, the vehicle moving status is entered (Block 326). If not, a determination is made whether the vehicle was ON (Block 358) and if yes, the vehicle ON mode is entered (Block 358). If the vehicle was not ON, a determination is made whether the proximity communication device blinks active (Block 360) and if yes, the cycle repeats. If not, telemetry is written to the tag (S=2) as two telemetry blinks (Block 362).

A 20 second tag task timer is initiated (Block 364) and telemetry requests are sent every one second (Block 366). A determination is made whether the 20 second timer has expired (Block 368) and if not, the cycle repeats. If yes, a determination is made whether the vehicle is moving (Block 370) and if yes, a vehicle moving mode is entered (Block 326). If not, a determination is made whether the vehicle is ON (Block 372) and if yes, the vehicle ON mode is entered (Block 330). If not, the determination is made whether the proximity communication device blinks active (Block 374) and if yes the cycle repeats. If not, the vehicle identification number is written to the tag as two VIN blinks (Block 376) and the 20 second tag task timer initiated (Block 378). The sleep mode is entered (Block 380).

FIG. 9 is a flow chart showing the function of the automotive tag when the vehicle moving status (Block 326) is entered. At that time, telemetry requests are sent every second (Block 482). A determination is made whether the 20 second timer has expired (Block 484) and if not, the cycle repeats and telemetry requests are sent every second. If yes, a determination is made whether the vehicle is OFF (Block 486) and if yes, the vehicle OFF mode is entered (Block 488). If not, a determination is made whether the vehicle is moving (Block 489) and if yes, the ten minute timer is initiated (Block 490). At this time, a determination is made whether the proximity communication device blinks active (Block 492) and if yes, the cycle repeats. If the vehicle is determined not to be moving at Block 489, the determination for the proximity communications device at Block 492 is made. At this time, telemetry is written to the tag (S=4) with two telemetry blinks (Block 494). The 20 second tag task timer is initiated (Block 496), and a determination is made whether the ten minute timer has expired (Block 498). If not, the cycle repeats as at the beginning, but if yes, an idle mode is entered (Block 500).

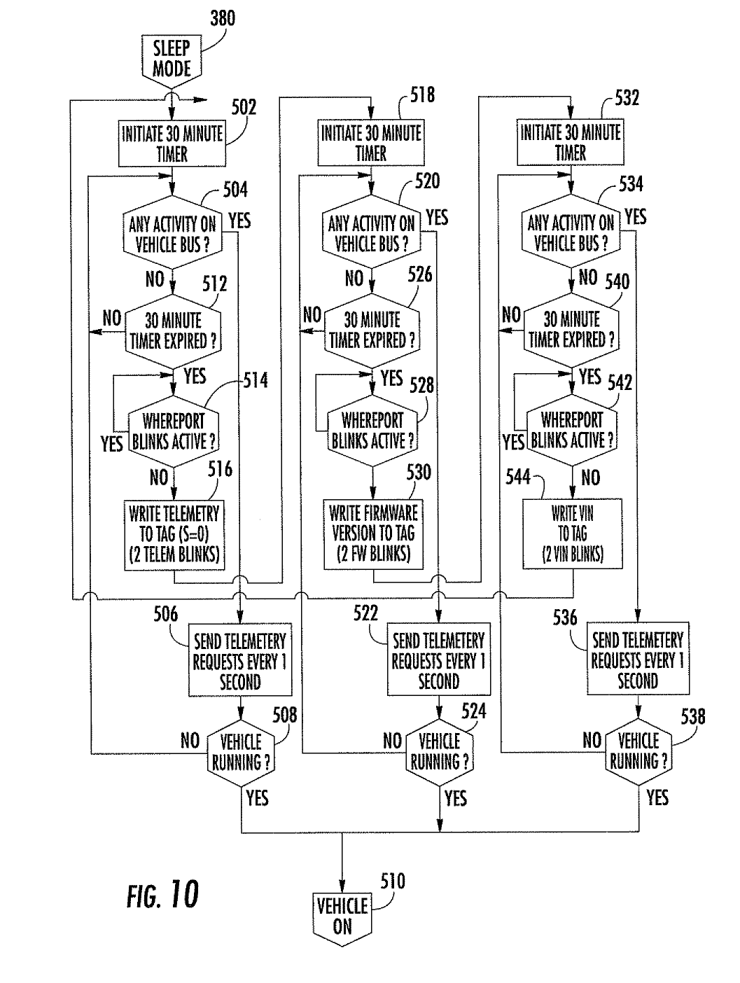

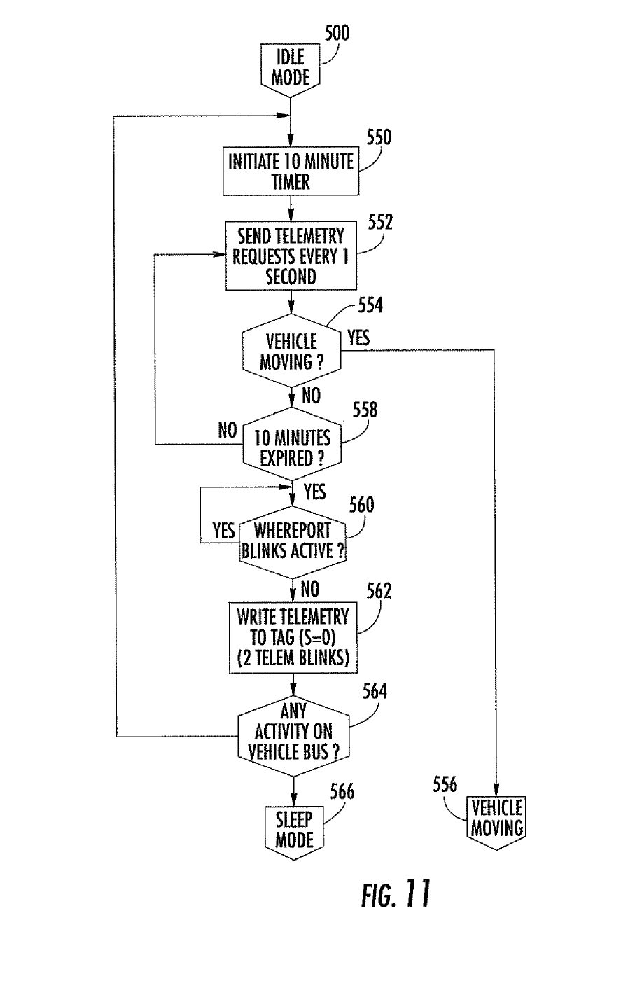

FIG. 10 shows the function of the vehicle tag when the sleep mode is entered (Block 380). At this time, a 30 minute timer is initiated (Block 502) and a determination is made whether any activity occurs on the vehicle bus (Block 504). If yes, telemetry requests are sent every one second (Block 506). A determination is made if the vehicle is running (Block 508) and if yes, a vehicle ON status is entered (Block 510). If not, the cycle repeats to determine whether any activity occurs on the vehicle bus (Block 504). If at this time, if no activity is on the bus, a determination is made whether the 30 minute timer has expired (Block 512) and if not, the cycle repeats to determine if any activity is on the vehicle bus. If yes, a determination is made whether the proximity communication device blinks action (Block 514) and if yes, the cycle repeats. If not, telemetry is written to the vehicle tag (S=10) as two telemetry blinks (Block 516). At this time, the 30 minute timer is initiated (Block 518).

A determination is made whether any activity is on the vehicle bus (Block 520) and if yes, telemetry requests are sent every second (Block 522). A determination is made whether the vehicle is running (Block 524) and if yes, the vehicle ON status is indication (Block 510). If there is no activity on the vehicle bus, a determination is made whether the 30 minute timer has expired (Block 526), and if not, the cycle is repeated. If yes, a determination is made whether the proximity communication device blinks action (Block 528) and if yes, the cycle repeats. If not, the firmware version is written to the tag with two FW blinks indicative of the firmware (Block 530).

The 30 minute timer is initiated (Block 532) and a determination is made whether any activity occurs on the vehicle bus (Block 534). If yes, telemetry requests are sent every second (Block 536) and a determination is made whether the vehicle is running (Block 538). If yes, the vehicle ON status is indicated (Block 510). If not, the cycle is repeated. If there is no activity on the vehicle bus, a determination is made whether the 30 minute timer has expired (Block 540). If yes, a determination is made whether the proximity communication device blinks active (Block 542) and if yes, the cycle is repeated. If not, the vehicle identification number is written to the vehicle tag as two vehicle identification number blinks (Block 544) and the cycle repeats back to Block 502.

FIG. 11 is a flow chart showing the function of the vehicle tag in the idle mode (Block 500). A ten minute timer is initiated (Block 550) and telemetry requests are sent every one second (Block 552). A determination is made whether the vehicle is moving (Block 554) and if yes, the vehicle tag enters a vehicle moving mode (Block 556). If not, a determination is made whether a ten minute timer has expired (Block 558) and if not, telemetry requests are sent every second. If the ten minute timer has expired, a determination is made whether a proximity communication device blinks active (Block 560). If yes, the cycle repeats and if not, telemetry is written to the tag (S=0) as two telemetry blinks (Block 562).

A determination is made whether any activity is on the vehicle bus (Block 564) and if not, the vehicle tag enters a sleep mode (Block 566). If yes, a ten minute timer is initiated and the cycle repeats.

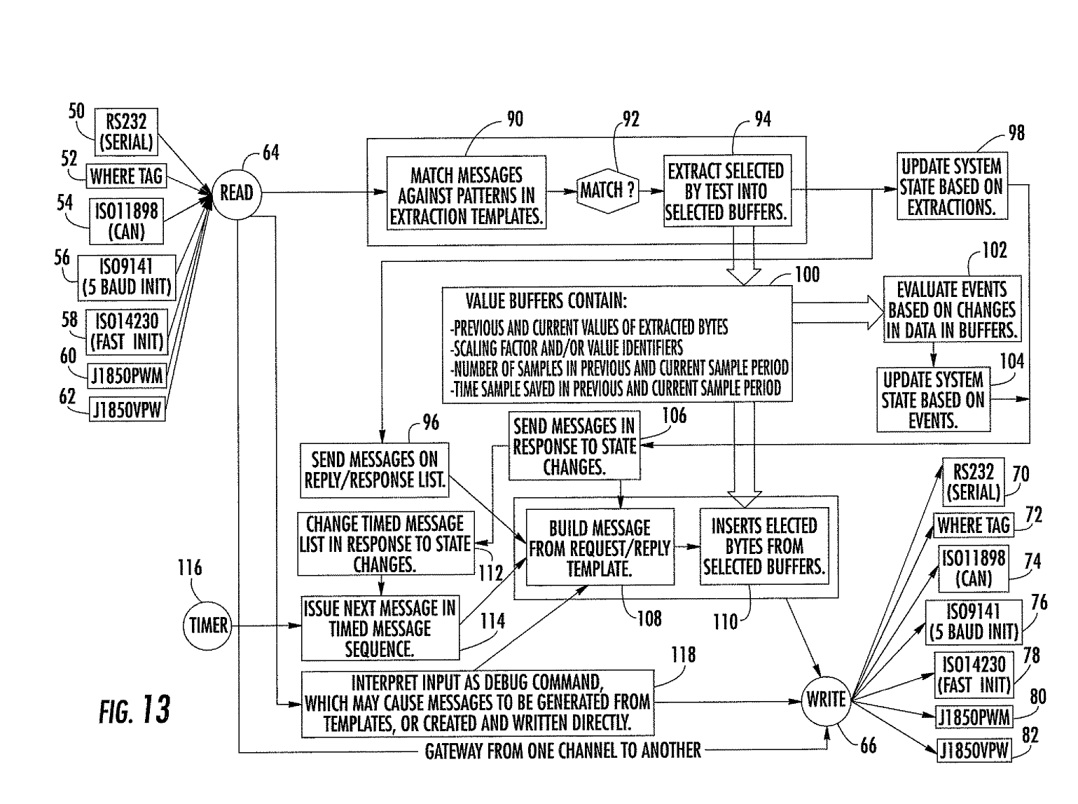

FIG. 12 shows the interrelationship among the proximity communication device, for example, a WherePort device (Block 600), and the different modes indicated by the sleep mode (Block 602), ON mode (Block 604), OFF mode (Block 606), moving mode (Block 608), idle mode (Block 610) and connect mode (Block 612).

The vehicle tag 20 of the present invention includes run-time firmware and vehicle data tables that allow the vehicle tags to work with different vehicles having variations in their OBD-II systems. The firmware and vehicle data tables are operative with each other. When a vehicle identification number (VIN) is determined and written into the vehicle tag 20, the firmware in the vehicle tag 20 automatically obtains information regarding the vehicle and its operation from the vehicle data tables in the vehicle tag such that the vehicle tag is operative with that vehicle.

The vehicle tag of the present invention can communicate with a wide range of vehicles even when vehicles exhibit extreme variations in system and circuit behavior and protocol from model to model. The vehicle tag of the present invention can also be extended to new vehicles and new applications without requiring changes to any core firmware. Any embedded firmware runs on a processor of the microcontroller 32 with limited read-write memory. Various end-tag components can include a loader that allows for “in the field” table and run-time flash updates. Any vehicle data tables tailor the vehicle tag of the present invention to a specific application. A run-time component can act as a general purpose packet exchange state machine.

The vehicle tag of the present invention could be operative with various external components, including a hand-held device to provide files and information to update and configure the vehicle tags and a programmer that could drive “in the field” flash updates. A table builder could compile CSV tables into ST9 binary images, which a table browser or maintenance utility could allow for viewing and/or updating and extending tables. ST9 is a microprocessor design that could include a multiple register based microcomputer core, A/C converters, serial communication interface units (SCI's), 16-bit multifunction timers, and input capture/output compare capabilities.

The ST9 microcontroller series is manufactured by STMicroelectronics and is a high-performance MCU family which bridges the gap between 8 and 16 bit microcontrollers, offers fast program execution, efficient use of memory, fast data handling and context switching with input/output flexibility and system expansion. It can include single voltage flash and emulated EEPROM, and 256 Kb single-voltage flash and PLL clock generation that is fully programmable. There can be different programmable inputs/outputs, analog-to-digital converters, linear memory, 8-bit registers, and CAN 2.0 B active with enhanced filtering. Other components can be found in the various data sheets for the ST9 family of microcontrollers as manufactured by STMicroelectronics.

FIG. 13 shows a run-time message flow that can be operative as one example for the vehicle tag of the present invention. Inputs are read, as shown by the inputs on the left and outputs are written, as indicated by the outputs on the right.

As indicated, various inputs include the RS232 serial 50, a WhereTag input 52, ISO11898 (CAN) 54, ISO9141 (five baud INIT) 56, ISO14230 (fast INIT) 58, J1850PWM 60 and J1850 VPW 62. These are read by selected “read” circuitry 64 and written through “write” circuitry 66. Corresponding functions at the “write” output are given the numbers 70-82 corresponding to the numbers 50-62 as the “read” inputs.

Also, other functions occur in the message flow, including matching messages against patterns in extraction templates 90, determining if a match occurs 92, and selecting extracts by test into selected buffers 94. Messages can be sent on reply/response lists 96 and the system state updated based on extractions 98. Value buffers contain previous and current values of extracted bytes, scaling factor and/or value identifiers, number of samples in previous and current sample period, and time samples saved in previous and current sample period as indicated at Block 100. Events can be evaluated based on changes in data in the buffers 102 and the system state updated based on events 104. Messages can be sent in response to state changes 106 and messages built from requests/reply template 108 and insert the selected by test from selected buffers 110, which are then read 66. Also, the change in time message list and response to state changes can occur 112 and a next message issued in timed message sequence 114 as determined by a timer 116. The input can be interpreted as a debug command, which may cause messages to be generated from templates, or created and written differently 118. The gateway from one channel to another exists between the read and write.

All input channels are uniform. Any channel can carry telemetry, debug, or gateway information. The read function is responsible for routing messages to the right destination. All output channels are uniform. Time based template generated messages, response messages, debut messages, and gateway messages can all be sent on any channel, which are designated as telemetry in, telemetry out, debut in, debug out, or gateway by setting bits in EEPROM.

Messages coming in on channels which are designated as telemetry inputs are processed using extraction templates. Extraction templates can save data in buffers, change the system state, or cause multiple response messages (which can be sent-out on multiple channels). Extraction templates are based on pattern matching, and thus, are not limited to vehicle messages.

Telemetry outputs are built from templates. They can be triggered based on the passage of time, on the receipt of a particular message, on a change in system state, or by a debug command. The outputs can include constants and values from buffers, including scale factors, message counts, VIN data, and other metadata. Request/response templates build messages byte by byte from data stored in the vehicle tag, and thus are no more vehicle dependent than the particular extraction templates in use.

Messages coming in on channels which are designated as debug inputs can be processed by a debug command processor. They can perform a wide variety of development and test functions. Outgoing debug messages can be created from templates or created directly. The vast majority of debug outputs are execution trace messages.

As all channels are uniform, two channels can be gatewayed together, such that all messages coming in on one channel can be sent out the other channel. This would allow a laptop with RS232 to talk directly to a vehicle's J1850VPW bus, as one example.

The selection of extraction templates and request/reply templates is controlled by classical state machines. These contain entries of the form:
If in state S and event E occurs, go to state N, activate tables T, and execute action A. The selection of which state machines are used is controlled by the Family code, which in turn is determined by the VIN.

The vehicle tag of the present invention can be tailored to a specific application. If there is a vehicle from which the system is to determine fuel and mileage, it can add the capability to eavesdrop for engine coolant temperature (ECT), for example. The vehicle tag can see the temperature rise from below 240 to above 240, and enters a new state. It could also blink a warning message.

The system operative as the vehicle tag can identify active tables, update an extraction set, create extraction templates, create analysis methods, define value buffers, define events, update primary state machines, update telemetry state machines, update response lists, and create response templates. These functions are described below.

Active tables can be identified. Using a Table Development Utility, it is possible to determine which family, state machine, dialect, sequence, set, checklist, and other tables are active for vehicles in this VIN family.

An extraction set can be updated. In a current SetToExtaction table, the vehicle tag system can add the template “EXTRACT_ECT” to the lists of templates to apply to incoming messages. The system specifies a “NULL” reply list for this template. In the ExtractionNumToBase table, the system assigns the symbolic name “EXTRACT_ECT” to the next available extraction template slot.

An extraction template can be created. The system creates a new Extraction template table named “EXTRACT_ECT” in the Extractions directory. The “match” portion of the template is set to match messages where the first five bytes are 0x48,0x6B,0x10,0x41,0x05. The system sets the “analyze” portion of the template to apply the “ECT_ANALYSIS” analysis method to the sixth and seventh bytes of the message. The “state change” portion of the template is left empty.

An analysis method can be created. In AnalysisNumToBase, the system assigns the symbolic name “ECT_ANALYSIS” to the next available analysis slot. The system creates a new analysis table with a single method in the “Analyses” subdirectory as follows:
Set the buffer to “ECT_BUFFER”;
Set the save flag to “SAVE_CURRENT”; and
Set the scale factor to 1.

Value buffers can be defined. In BufferToName, the system assigns the symbolic constant “ECT_BUFFER” to the next available buffer as follows:
Set the averaging to “none”;
Set the size to 2 bytes; and
Set the flags to “none.”

Events can be defined. In EventToName, the system assigns the symbolic constant “OVERTEMP_EVENT” to the next available event slot. In an appropriate ChecklistToEvent table, the system adds an entry to trigger this event as follows:
Set the buffer to “ECT_BUFFER”;
Set the field to “CURRENT_VAL”;
Set the comparison to “RISING_PAST THRESHOLD”;
Set the threshold to 240; and
Set the event to “OVERTEMP_EVENT”.

A primary state machine can be updated. In StatePrimaryToName, the system assigns the symbolic constant “OVERTEMP_STATE” to the next available primary state slot. In the appropriate StateNexts table, the system adds an entry to respond to the event as follows:
Set the previous state to “ENGINE_ON”;
Set the comparison and secondary state to trigger enable the trigger in all secondary states;
Set the event to “OVERTEMP_EVENT”; and
Set the next primary state to “OVERTEMP_STATE”.

A telemetry state machine can be updated. In the appropriate StateTelemetries table, the system adds an entry to send a message when entering this state. The system sets the primary state to “OVERTEMP_STATE” as follows:
1) Set the comparison and secondary state to trigger on entry to the primary state; and
2) Set the response list to “OVERTEMP_LIST”.

A response list can be updated. In ListNumToBase, the system assigns the symbolic constant “OVERTEMP_LIST” to the next available reply/response list slot. The system creates a new response list table containing a single response in the Lists subdirectory as follows:
Set the response template to “OVERTEMP_BLINK”.

The system can create a response template. In RequestNumToBase, the system assigns a symbolic constant “OVERTEMP_BLINK” to the next available request/reply template slot. The system creates a new response template table in the Requests directory as follows:
Set the channel to “TAG”;
Set the constant portion of the template to 0x41, . . . , . . . ,0x00, 0x00, 0x00, . . . ; and
Set the insertion portion of the template to insert the contents of “ECT_BUFFER” into message bytes 1,2.

The extraction template will use the analysis method to capture ECT into a value buffer. The event and checklist will update the primary state machine when the ECT crosses the threshold. At the state transition, the telemetry state machine will activate a response list containing the response template, which will build the message to blink from the tag.

The vehicle tag of the present invention also builds tables. The tag can include a highly portable command line utility, with various actions, including: (a) reads loader and run-time files; (b) reads CSV table files into memory; (c) builds symbol tables; (d) resolves symbols in tables and links between tables; (e) writes-out annotated CSV table files; (f) merges table information with firmware; and (g) writes-out packed and aligned ST9 hex image files as follows:
Loader only, tables only, run-time only, full memory image.

The system can maintain a table through a Table Maintainer function (or module). It is executable in a similar fashion as the Table Builder module, but runs as a web server and web service. It would include the capabilities to: (a) browse existing tables; (b) execute queries against existing tables; (c) modify and update fields in tables; (d) assist in developing new tables; and (e) assist in developing new applications.

There may be some limitations, however. Run-time is packet oriented. The data on a communication channel must be organized as small discrete packets. Run-time is also byte oriented. The finest granularity that data can be processed is at the byte level. Run-time is based on pattern matching and byte extraction and insertion. The vehicle tag can perform only the simplest of calculations on the data.

Different hardware and software functions are also operable in and with the vehicle tag of the present invention. A hand-held can be used to configure the tag to a specific vehicle by downloading the VIN number, tag ID, tag configuration, and other information. A hand-held can also be used to update the tables data and run-time firmware contained in only flash memory.

A programmer module for the vehicle tag can interface to a hand-held. It would provide robust communications from a RS232 interface to a ISO14230 interface in the vehicle tag. Any vehicle tag configuration and updates are mediated by this programmer module, which also serves as the basis for a portion of the automatic test system in production.

A loader in the vehicle tag interfaces to the programmer connected to a hand-held. The loader module performs any actual programming of the emulated EEPROM with this configuration, and of the flash memory with updates. The loader is also responsible for initializing the vehicle tag in the system.

The tag tables tailor the vehicle tag to a particular application. For example, a set of vehicle data tables direct the vehicle tag to request and collect telemetry data from the vehicle, and blink that telemetry using the transceiver circuitry in the vehicle tag. In the future, other table sets could be developed to tailor the vehicle tag to entirely different applications.

A vehicle tag run-time is operable as a general purpose packet exchange state machine. It makes use of a set of tables to show how data is extracted from incoming messages, and how outgoing messages are built using that data. Changes in the data can trigger events, which can cause state machine transitions that modify the operation of the vehicle tag. The current run-time supports communication as over RS232, a WhereTag communication standard developed by WhereNet Corporation, ISO11898 (CAN), ISO9141 (5 baud init), ISO14230 (fast init), J1850PWM, and J1850VPW, as shown in FIG. 13.

A highly portable command line utility is operable in a table builder utility. It can read loader and run-time files; read CSV table files into memory; build symbol tables; resolve symbols in tables and links between tables; write out annotated CSV table files; merge table information with firmware; and write out packed and aligned ST9, hex image files as follows:
Loader only, tables only, run-time only, full memory image.

A table maintainer function can be executable as a table builder, but runs as a web server and web service. It could browse existing tables; execute queries against existing tables; modify and update fields in tables; assist in developing new tables; and assist in developing new applications. An tag constants table can provide a bridge between symbolic constants in any run-time firmware and those in the tables.

Every vehicle has a unique vehicle identification number (VIN). The vehicle tag can make use of a tailoring string to control its operation. This tailoring string would contain no actual configuration parameters, but correspond to a pattern that is used to look-up the “real” configuration information in the tables. Thus, with appropriate table entries, any identification string can be used as the tailoring string. This could include part numbers, serial numbers, product names, and related data. For a vehicle tag application, the VIN serves as the tailoring string. Numerous “pseudo” VINs are also used to control various development, test, and simulation modes.

A VinToDesription table could contain detailed information used to decode VINs, such as on a hand-held. It could contain more detailed information than what the run-time actually requires. Unlike other VIN tables, VinToDescription would not treat the VIN as an arbitrary string, but actually understand the significance of specific character positions. VinToDescription typically would not be downloaded into the vehicle tag.

A VinToWmi table could contain one of two subsets of VIN information required by the tag. There is a record in this table for each Worldwide Manufacturer Identifier.

The VinToFamily table contains the reset of the information about tailoring strings that is necessary for configuring a specific tag. For the vehicle tag, records in the VinToFamily table associate VIN substrings with configuration parameters. Several tables can be used to display the vehicle year, make, and line to the developer. As these are not essential to the operation of the tag, they are stored in an otherwise low utility section of flash.

Two family tables select which primary state machines, dialect state machines, telemetry state machines, and event checklists are active for this configuration. A primary (or next state) state machine vehicle controls a long time frame (multi-second) state of the vehicle tag. In the vehicle application, the primary state machine is concerned with keeping track of vehicle starting, moving, and stopping. A message (or telemetry) state machine controls the sending of messages based on primary and secondary state changes. A dialect state machine determines how the sequences and sets of messages sent and interpreted changes over time.

A DialectToSequence table enables a specific set of communication channels, and selects (a) a timed request message sequence to send messages, (b) a default extraction set to interpret messages, and (c) a message byte override table to modify both.

An OverrideToValue table modifies request and extraction templates in small ways, such as changing an address or a scheduling byte. This allows similar but not quite identical messages to share message template.

A request sequence tables defines the order and timing of messages that are sent out on a timed basis. They also determine the set of extraction templates that will be used to interpret responses to each message.

A request template table defines the actual bytes that go into outgoing messages. The message bytes can consist of constants, override values, values from buffers, scale factors, compressed VINs, state numbers, and many other pieces of data.

A SimulatorToConstants table defines outgoing messages that are composed entirely of constant values, cannot be overridden, and cannot be triggered by debug commands. It is primarily used by the five vehicle simulators built into the tag.

An extraction set table determines the sets of templates that are used in interpret and extract data from incoming messages. Extraction templates can be used to determine how incoming messages are processed. They define the pattern match that must occur for a message to be recognized by the template and the set of analysis methods to apply to extract data from the message.

Analysis methods tables determine how to process bytes extracted from messages. They determine what combination of newest, oldest, maximum, minimum, and non-zero values should be stored in which set of buffers.

A BufferToName table determines the size of the data in the buffer and what averaging algorithm, if any, to apply to a buffer. It also determines how to handle missing values, unexpected zero values, and accumulated values. Reply lists define the messages that are sent out in direct response to incoming messages.

Event checklists can be used to determine which events are triggered by what combination of changes in the value buffers. Events can be triggered on a diverse selection of criteria, for example, a value rising about a threshold, a scale factor changing, the number of messages per sample period decreasing at too high a rate, or even two different samples alpha sorting in different orders. A VersionBuild table contains the version number and build date for software. In addition, it specifies what versions of the run-time this table set is compatible with.

A run-time program can initialize all the hardware, and can configure and start the software modules, and start the scheduler. A scheduler function would have a 5 ms minimum time quanta, but would not impose a single fixed schedule on the tasks, but rather allow them to change their scheduling on every invocation.

Different scheduled tasks are available. These functions can collect messages from the various communication channel queues, and route them to the appropriate destinations. They can analyze the data in the value buffers, and update the state depending on the resulting dialects, message sequences, and extraction sets. They can initiate the building and sending of time based messages and handle the routing of all outgoing messages.

Other message processing functions can provide a wide variety of development, testing, and debugging commands and support. These functions can extract data from incoming messages based on extraction templates, and build outgoing messages based on request/response templates. They can check VIN number validity and compress VIN numbers.

Message queuing, channel protocols, including protocol specific state machines, and interrupt service routines, are operable in the vehicle tag of the present invention. A function can direct the initialization of the EEPROM, an interrupt vector table, unused I/O ports, a reset and clock control unit, and a watchdog timer. A timer function provides a 5 ms timer that provides a time base for the scheduler. A battery function controls the reading of vehicle battery voltage.

Hardware specific interfaces exist for: (a) controller area network (CAN); (b) J1850 byte level protocol decoder; (c) asynchronous serial communications interface; (d) multi-protocol serial communications interface; (e) serial peripheral interface; and (f) WhereTag x-wire interface.

Hardware specific interfaces exist for: (a) analog to digital conversion; (b) emulated EEPROM; (c) interrupt handling; (d) I/O ports; memory management unit; (e) reset and clock control unit; (f) standard timer; and (g) watchdog timer.

A debug function provides debug message support, including execution trace, usable from all other modules. A memory function provides dynamic memory management for message packet structures, allocating memory from a common pool.

Channel interchangeability does not add excessive amounts of code. Originally, each channel had its own architecture. The channel software can be written to force all channels to use the same architecture. This reduces the overall size of the code, since the system share many supporting routines. Features such as gatewaying messages and allowing any channel to be defined as either debug parsed or template parsed can be maintained.

It should be understood that there is a tremendous variation in the communications behavior and protocols from vehicle to vehicle. It is not practical to eavesdrop on the bus. Thus, it is necessary to prod the vehicle on a timed basis. With some systems, it is necessary to execute elaborate prompt-response sequences. On J1850VPW alone, there are seven bit headers, eight bit headers, three byte consolidated headers with logical addresses, three byte consolidate headers with physical addresses, three byte unconsolidated headers and others. Every feature in the tag is used by some vehicle or another. The present invention is advantageous because each feature is not artificially restricted to only working on vehicles and nowhere else.

It is also possible to use a pocket PC application. Different cars encode their telemetry data in different ways. These encodings are often not public, but they will become available over time. As a result, the encodings cannot be hard coded into the vehicle tag firmware. As a solution, the vehicle tag firmware should look up decoding schemes for each car in a configuration file. A pocket PC application could update this configuration file and write the vehicle identification number for each car. For example, a vehicle tag adapter could connect to the vehicle tag by a communications line. The vehicle tag adapter would connect to a hand-held unit, such as a Symbol PDT 8100 device. It would include a power and serial communications to hardware, an HTTP communication to a WhereNet server, a scanning interface for the vehicle identification number, and configuration files and software upgrade. A hardware pipe could be operable and tag firmware could use the vehicle identification number to key into the tag tables and determine how to decode telemetry data from the vehicle. It could use serial communication. The vehicle tag adapter could hold tag firmware and a tag table and the hand-held unit could check for version differences in data modules on a pocket PC with those on the adapter. If different, it could write modules to the vehicle tag adapter.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1-43. (canceled)

44. A method of transmitting vehicle telemetry data, which comprises:
receiving vehicle telemetry data in a vehicle tag through a diagnostic jack of a vehicle on-board diagnostic (OBD) system; and
transmitting the telemetry data from a tag transmitter contained within the vehicle tag as a RF pulse.

45. A method according to claim 44, which further comprises connecting a tag connector carried by the vehicle tag to the diagnostic jack of the OBD system.

46. A method according to claim 44, and which further comprises transmitting the RF pulse as a pseudo random spread spectrum RF signal encoded with the telemetry data.

47. A method according to claim 44, which further comprises receiving the vehicle telemetry data through a tag connector that comprises a J1962 compatible connector.

48. A method according to claim 44, which further comprises receiving a vehicle identification number (VIN) from the OBD system and determining a vehicle bus protocol for communication based on a received VIN.

49. A method according to claim 44, which further comprises storing data relating to different vehicle bus protocols within the vehicle tag for allowing communication of a vehicle tag with different vehicles having different bus protocols.

50. A method according to claim 44, which further comprises drawing power for the tag transmitter from the OBD system through the diagnostic jack.
